(19) United States
(12) Patent Application Publication
(10) Pub. No.: US 2026/0011060 A1
(43) Pub. Date: Jan. 8, 2026

(54) APPARATUS AND METHOD FOR GENERATING MEDIA CONTENT BASED ON GENERATIVE AI

(71) Applicant: Electronics and Telecommunications Research Institute, Daejeon (KR)

(72) Inventors: Hyun-Jeong YIM, Daejeon (KR); Jae-Hyun SEO, Daejeon (KR); Sung-Jun AHN, Daejeon (KR); Jung-Sun UM, Daejeon (KR); Bo-Mi LIM, Daejeon (KR)

(21) Appl. No.: 19/185,556

(22) Filed: Apr. 22, 2025

(30) Foreign Application Priority Data
Jul. 8, 2024 (KR) 10-2024-0089819

(51) Int. Cl. G06T 11/60

(52) U.S. Cl. CPC G06T 11/60

(57) ABSTRACT

Disclosed herein is an apparatus and method for generating media content based on generative AI. The apparatus generates combined media by combining existing media with synthetic media generated using a generative AI, defines metadata required for the generative AI to generate media content for the combined media, and generates the media content using the generative AI by adjusting the text prompt to be input into the generative AI using the metadata.

### CROSS REFERENCE TO RELATED APPLICATION

This application claims priority under 35 U.S.C § 119 to Korean Patent Application No. 10-2024-0089819 filed in the Korean Intellectual Property Office on Jul. 8, 2024, which is hereby incorporated by reference in its entirety into this application.

### BACKGROUND OF THE INVENTION

### 1. Technical Field

The present disclosure relates generally to media transmission/reception technology, and more particularly to technology for generating media content based on generative AI.

### 2. Description of the Related Art

Existing media transmission and reception systems have focused on accurate transmission of large amounts of data, high transmission speeds, low compression rates, and rapid synchronization. Therefore, the accuracy of transmitted and received data was of utmost importance in terms of content encoding, decoding, transport, and transmission. The primary goal of transmission and reception was to ensure that data output from a transmitting end precisely matches data received through the input interface of a receiver. In order to overcome issues in the data transmission process, transmission and reception technology has been developed to deliver more data with greater precision and speed and to provide service by reproducing content at the receiving end that exactly matches the content produced at the transmitting end. However, the conventional transmission and reception methods are no longer adequate to accommodate diverse and complex demands of users and rapidly evolving media environments.

Media semantics encompasses technologies and concepts that assign semantic information to media content and utilize the information. This plays a critical role in improving the search, analysis, recommendation, and personalization of media content. Technologies related to media semantics include MPEG 7 and MPEG 21 defined by MPEG, and additional standards related to semantic metadata include TV-Anytime and Open Mobile Alliance Broadcast (OMA-BCAST). However, these technologies are primarily focused on technology for selecting suitable content for users at a media production stage or in a unicast-based media streaming service or on media archiving for search, metadata management, and understanding content information for using content as data for announcement in broadcast services.

Meanwhile, Korea Patent Application Publication No. 10-2024-0016525, titled “Method for providing customized video production services”, discloses a method for providing a customized video production service in which user options, such as concepts, costumes, hair, and the like, are reflected.

### SUMMARY OF THE INVENTION

An object of the present disclosure is to facilitate the efficient production, distribution, and reprocessing of media content and to build a new media service environment that more precisely responds to the preference and demand of individual users.

Another object of the present disclosure is to generate and optimize data in real time at a media edge or a receiver, thereby providing a continuous and seamless media experience.

A further object of the present disclosure is to enhance user experiences and overall service transmission and reception efficiency by using a media content service transmission network more efficiently than existing services.

Yet another object of the present disclosure is to provide customized content to users and optimize network resources by intellectualizing the process of delivering and generating media content.

Still another object of the present disclosure is to enable a variety of rich media experiences while significantly reducing the amount of data transmission, thereby greatly improving user satisfaction.

Still another object of the present disclosure is to provide seamless content viewing to users by generating media content even when media transmission is interrupted.

In order to accomplish the above objects, an apparatus for generating media content based on generative AI according to an embodiment of the present disclosure includes one or more processors and memory for storing at least one program executed by the one or more processors, and the at least one program generates combined media by combining existing media with synthetic media generated using a generative AI, defines metadata required for the generative AI to generate media content for the combined media, and generates the media content using the generative AI by adjusting the text prompt to be input into the generative AI using the metadata.

Here, the at least one program may combine the existing media with the synthetic media by reflecting information input by a user at a receiving end where the media content is received.

Here, detailed information about the text prompt may be defined in the form of metadata.

Here, the metadata may include constraint information that specifies criteria for a part of content in which the original of the media content should remain unchanged and a part of the content allowed to be modified by the generative AI.

Here, the constraint information may include guidelines for modifying the part of the content allowed to be modified by the generative AI according to a specific condition.

Here, the generative AI may freely modify the part of the content allowed to be modified by the generative AI when the constraint information does not include the guidelines for modification according to the specific condition.

Here, the metadata may include user profile and preference information for providing the media content to be customized to a user.

Here, the metadata may include information about priority for the generative AI to process most important information first when generating the media content.

Here, the metadata may include tagging information explicitly added for the generative AI to understand the meaning of individual elements in the media content.

Here, the at least one program may track and analyze the behavior of a user using the media content and the response of the user to the media content and store feedback for media content recommendation as the metadata.

Also, in order to accomplish the above objects, a method for generating media content based on generative AI, performed by an apparatus for generating media content based on generative AI, according to an embodiment of the present disclosure includes generating combined media by combining existing media with synthetic media generated using a generative AI, defining metadata required for the generative AI to generate media content for the combined media, and generating the media content using the generative AI by adjusting the text prompt to be input into the generative AI using the metadata.

Here, generating the combined media may comprise combining the existing media with the synthetic media by reflecting information input by a user at a receiving end where the media content is received.

Here, defining the metadata may comprise defining detailed information about the text prompt in the form of metadata.

Here, the metadata may include constraint information that specifies criteria for a part of content in which the original of the media content should remain unchanged and a part of the content allowed to be modified by the generative AI.

Here, the constraint information may include guidelines for modifying the part of the content allowed to be modified by the generative AI according to a specific condition.

Here, the generative AI may freely modify the part of the content allowed to be modified by the generative AI when the constraint information does not include the guidelines for modification according to the specific condition.

Here, the metadata may include user profile and preference information for providing the media content to be customized to a user.

Here, the metadata may include information about priority for the generative AI to process most important information first when generating the media content.

Here, the metadata may include tagging information explicitly added for the generative AI to understand the meaning of individual elements in the media content.

Here, generating the media content may comprise tracking and analyzing the behavior of a user using the media content and the response of the user to the media content and storing feedback for media content recommendation as the metadata.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view illustrating a system for transmitting and receiving a media service based on generative AI according to an embodiment of the present disclosure;

FIG. 2 is a view illustrating transmission and reception concepts depending on a change in a media service cloud according to an embodiment of the present disclosure;

FIG. 3 is a view illustrating an image generated by a generative AI model using media semantic information according to an embodiment of the present disclosure;

FIG. 4 is a flowchart illustrating a method for providing a media content service based on generative AI according to an embodiment of the present disclosure;

FIG. 5 is a flowchart illustrating a method for generating media content based on generative AI according to an embodiment of the present disclosure; and

FIG. 6 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present disclosure will be described in detail with reference to the accompanying drawings.

Generative AI-based media may be an example of a new media service, and in the present disclosure, the configuration and content of the disclosure will be described taking Generative AI-based media as an example.

The present disclosure seeks a new technical approach in the processes of generating, delivering, and reproducing media content and discloses content distribution and consumption methods based thereon.

The present disclosure may maximize the efficiency of content creation by utilizing technology such as generative AI.

Here, the present disclosure may provide more customized and rich media experiences to end users by enhancing data transmission efficiency in a media content delivery process.

Here, the present disclosure enables only information required at a reception stage to be selectively delivered by using media semantics (or metadata), which is semantic information of media content.

Here, the present disclosure proposes a new type of media transmission/reception system that enables a seamless streaming service by generating additional content in real time through generative AI at a receiver or edge according to need.

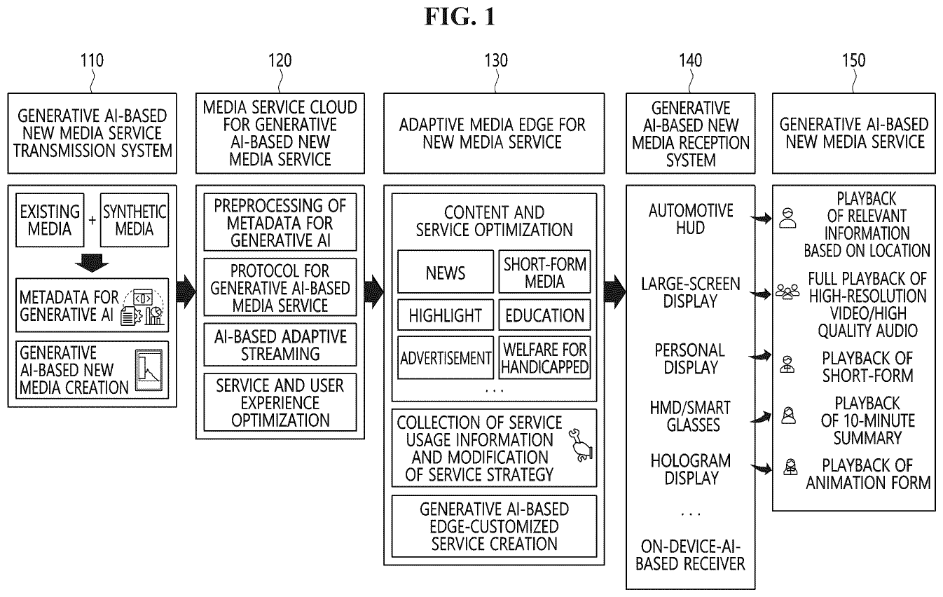

FIG. 1 is a view illustrating a system for transmitting and receiving a media service based on generative AI according to an embodiment of the present disclosure.

Referring to FIG. 1, it can be seen that a future media content service provides more user-friendly and customized experiences to users by generating, managing, and distributing media content using AI and machine learning.

The service transmission/reception system using media semantics presents a service transmission/reception system that uses media semantics technology in a media creation and delivery process to efficiently create, distribute, and reorganize a service. The reasons why the use of media semantics is required to transmit and receive services areas follows.

First, as content creation techniques using cutting-edge technology such as generative AI emerge as innovative solutions capable of saving time and resources, a more dynamic and flexible media delivery method is required to make the best use of these evolving content creation techniques.

Also, the existing method enables the content of data delivered for a service to be identified in a broad form, such as at EPG and ESG levels, but this information is not sufficient to identify the specific content of the delivered data, that is, the detailed meaning or importance of the data.

This is because in the conventional media delivery method, the role of delivery was simply to sequentially transmit packets to prevent packet loss. Therefore, until the received broadcast content is fully viewed, it is impossible to know the content thereof, and user's interests cannot be immediately reflected. For example, even if there is content that a user absolutely wants to avoid or watch due to the personal characteristics, there is no method to identify the content.

In order to overcome these problems, the present disclosure presents a new type of media transmission/reception technology that utilizes cutting-edge technology such as generative AI in the process of creating and delivering media content.

The present disclosure proposes a method capable of improving the efficiency and flexibility of media delivery departing from the data transmission method of the existing broadcast system, thereby presenting a new broadcast and media delivery system structure that maximizes user experiences and makes intelligent use of network resources.

The present disclosure describes a new transmission/reception system capable of identifying the meaning and importance of data in a media delivery process and suitably providing content customized to individual demands of users through generative AI based on the identified information.

This enables a part of content to be generated in real time at a media edge or a receiver and enables personalized services to be provided to users, whereby it is possible to respond to changes in the media industry and provide new user experiences.

Generative AI may be used to create media in a media transmission system and may also be used in a reception system at a service cloud media edge, and key information (media semantics, metadata, etc.) transmitted from the transmission system enables media content to be reprocessed and reproduced during the delivery of the media content in the entire media delivery process.

A generative AI-based new media service transmission system 110 may generate a new type of combined media by combining existing media with synthetic media generated using a generative AI (media generated based on AI).

Here, the generative AI-based new media service transmission system 110 may correspond to an apparatus for generating media content based on generative AI according to an embodiment of the present disclosure.

Here, the generative AI-based new media service transmission system 110 may define metadata required for the generative AI to generate media content for the combined media.

Here, the generative AI-based new media service transmission system 110 may analyze an existing media source.

Here, the generative AI-based new media service transmission system 110 identifies key data points (e.g., key scenes, characters, dialogue, etc.) in the existing media (broadcast or streaming content), and image and audio recognition technology, and the like may be used in this process.

Here, the generative AI-based new media service transmission system 110 may generate synthetic media based on generative AI (e.g., images, text, audio clips, etc. generated by AI).

Here, the generative AI-based new media service transmission system 110 may generate synthetic media that is highly related to the context of the existing media based on the analysis of the existing media source.

Also, the generative AI-based new media service transmission system 110 may add the synthetic media so as to be combined with the existing media in post-production.

Here, after producing a video using conventional technology, the generative AI-based new media service transmission system 110 adds synthetic media to specific scenes or elements, thereby enhancing multi-layered storytelling or diversity.

Here, the generative AI-based new media service transmission system 110 may select the target scene or element to which the synthetic media is added in the existing media.

Here, the generative AI-based new media service transmission system 110 may generate the synthetic image or video to be inserted into the target scene by utilizing an AI-based tool.

Here, the generative AI-based new media service transmission system 110 may combine the generated synthetic media with the existing media by utilizing a digital synthesis tool.

Here, the generative AI-based new media service transmission system 110 may generate richer content by adding additional elements to the already completed video (e.g., adding special effects, changing a background, or modifying specific characters or objects according to a new scenario).

Also, the generative AI-based new media service transmission system 110 may combine the existing media with the synthetic media in an integrated creation process.

Here, the generative AI-based new media service transmission system 110 may create media by preplanning the combination of the existing media with the synthetic media from the initial production stage.

Here, when creating media, the generative AI-based new media service transmission system 110 may plan the scene or element to be created as synthetic media in an initial concept storyboard creation stage.

Here, the generative AI-based new media service transmission system 110 may create synthetic media using A 1.

Here, the generative AI-based new media service transmission system 110 may combine the created synthetic media with the existing media (a live-action video) and perform final editing.

Here, the generative AI-based new media service transmission system 110 may improve efficiency in the creation process and increase flexibility in content creation (e.g., virtual reality (VR) or augmented reality (AR) content creation, interactive storytelling, etc.).

Also, the generative AI-based new media service transmission system 110 may perform dynamic synthesis for combining the existing media with the synthetic media by reflecting information input by a user at the receiving end where the media content is received in real time (service usage information and requirements of the user delivered from the receiving end to the transmitting end).

Dynamic synthesis may be performed not only at the service generation stage but also at the media edge or service receiving end.

Here, the generative AI-based new media service transmission system 110 may select and generate synthetic media content by processing and analyzing the requirements of the user in real time.

Here, the generative AI-based new media service transmission system 110 may analyze the user input data, direct and generate real-time synthetic media based on the user input data (creating a changed background, changed characters, etc. using AI and real-time rendering technology), and create synthetic media using an AI-based tool.

Dynamic synthesis may be performed at an existing media and streaming service level or at a graphics engine level.

Dynamic synthesis may be used in games, educational content, and the like in order to show different storylines or products depending on the selection or behavior of the user.

Also, the generative AI-based new media service transmission system 110 may perform adaptive storytelling-based synthesis.

Here, the generative AI-based new media service transmission system 110 may automatically adjust the storyline or content based on previous data, such as preferences of viewers.

Here, the generative AI-based new media service transmission system 110 may provide personalized content provision by considering the long-term service experience and preferences of the viewer.

Here, the generative AI-based new media service transmission system 110 may analyze user analysis data, such as the viewing history and preferences of the user.

Here, the generative AI-based new media service transmission system 110 may determine the synthetic media to be combined with the existing media based on the user analysis data.

Here, the generative AI-based new media service transmission system 110 may combine synthetic media with the existing media by creating customized content.

Here, the generative AI-based new media service transmission system 110 may continuously monitor user responses and update the content provision method in order to optimize the user experience.

Adaptive storytelling-based synthesis refers to a scenario in which a viewing genre, actors, and the like are adjusted depending on the past viewing history of the user, and a customized trailer, and the like may be created as synthetic media.

Adaptive storytelling-based synthesis may provide user profiling and content recommendation algorithms for long-term analysis of user data.

Also, the generative AI-based new media service transmission system 110 may combine the existing media resources with content that is generated by adjusting the detailed characteristics and attributes of content using media metadata, thereby generating new media.

Also, the generative AI-based new media service transmission system 110 may define metadata.

Here, the generative AI-based new media service transmission system 110 may define a metadata generation process and the structure and expression method of metadata.

Here, the generative AI-based new media service transmission system 110 may define detailed information about a text prompt for a generative AI in the form of metadata.

Here, the generative AI-based new media service transmission system 110 defines and describes detailed information about the content and intent of the text prompt, a situation in which the text prompt is used, and the like in the form of metadata, thereby enabling a generative AI to generate content that effectively reflects the intent of a creator.

Here, the generative AI-based new media service transmission system 110 may provide background knowledge required for a generative AI to generate appropriate content based on the provided text information.

Here, the generative AI-based new media service transmission system 110 may use a key image in order to generate a video after generating the key image by configuring a prompt that can be understood by the generative AI, and may set the key image as the information that should be delivered first.

Here, the generative AI-based new media service transmission system 110 may define a constraint or constraint information in media content delivery.

Here, the constraint information may be included in the text prompt information.

Here, the constraint information may be used to determine a part of content that should be delivered without change and a part of content allowed to be modified by a generative AI.

Here, the constraint information may include specific constraints applied to media content and information for clearly describing the aspects of content (e.g., image quality, audio integrity, important content elements, etc.) to which these constraints are applied.

Here, the constraint information may be delivered first in the content delivery and generation process, and may be used as key information based on which a customized service can be provided while reflecting the intent of a creator and service distributor when reprocessing and generating content.

In particular, the constraint information may specify criteria for a part of the content in which a specific content element should always remain unchanged as in the original and a part of the content allowed to be modified by a generative AI.

Here, the constraint information may specify objects that should not be altered and objects that can be altered in the media content and the method of processing the objects by AI.

Here, the constraint information may include guidelines for modifying the part of the content allowed to be modified by the generative AI according to a specific condition.

Here, when the guidelines for modification according to the specific condition are not included in the constraint information, the generative AI may freely modify the part of the content allowed to be modified by the generative AI.

Also, the generative AI-based new media service transmission system 110 may define media metadata based on which various forms of media input can be processed.

Media metadata refers to metadata required for a generative AI to process various forms of media input, such as an image, sound, a short video, and the like, as well as a text prompt, and may provide information about a media file itself.

The media metadata may include metadata that describes the method of using each type of media, the meaning, the context, and the like, and may include information, such as the creation date, length, format, copyright, and the like of media, for a generative AI to understand and appropriately process various forms of input.

Comprehensive metadata related to media orchestration refers to metadata for increasing the efficiency of content provision and enhancing user experiences in an environment in which various forms of media content and services are integrated.

Here, the comprehensive metadata related to media orchestration refers to comprehensive metadata including information about the topic, genre, purpose, characteristics, and the like of the media service and content to be generated, and may describe information about how, when, in which form the service or content is to be provided.

Here, the comprehensive metadata related to media orchestration may include combination-related strategy information about the method of providing different forms of media content to be customized to a user.

Also, the comprehensive metadata related to media orchestration may include user profiles and preference information such that content is created according to a specific situation and user requirements.

Here, the comprehensive metadata related to media orchestration may be used to define the direction and context of the content to be generated by AI.

Metadata for priority-based information delivery refers to metadata required to implement a mechanism for prioritizing the delivery of important information, among all the data delivered from the service transmitting end to a generative AI.

Here, the metadata for priority-based information delivery may define the importance of each information item and set priority of the information such that the generative AI processes the most important information first.

Here, the metadata for priority-based information delivery refers to metadata to be applied at the delivery stage in order to optimize the content generation process of the generative AI and to efficiently generate important content first.

Metadata related to content interaction refers to metadata about a method in which a user interacts with the generated content, and may be used later in order to enhance and personalize the service.

For example, the metadata related to content interaction may include information about the part of specific content in which a user is more interested or the response of the user.

Here, the metadata related to content interaction may include essential information for analysis of user behavior, extraction of preferences, and the mechanism of a content recommendation system.

Semantic tag metadata is for explicitly tagging individual elements or scenes in the content with the meaning thereof and for classifying the same, and the semantic tag for each part may be included as metadata.

Here, the semantic tag metadata may be used to help AI better understand the meaning of the content and to recommend relevant content or perform search (e.g., tag information about specific objects or scenes in a video).

Content version control metadata refers to metadata for managing different versions of generated content.

Here, the content version control metadata refers to metadata for recording information, such as how the content has evolved over time, the version that received a more positive response from a user, and the like.

Environmental and contextual metadata refers to metadata for information about the environment and context in which content is generated or consumed.

Here, the environmental and contextual metadata may include information such as the location of a user, a time zone, a device type, and the like, and may be used for a content distribution method.

Also, the generative AI-based new media service transmission system 110 may generate final media content.

Here, the generative AI-based new media service transmission system 110 adjusts the text prompt to be input into a generative AI using metadata, thereby generating media content using the generative AI.

Here, the generative AI-based new media service transmission system 110 may repeat the process of updating a profile by collecting and analyzing user data through user profiling and data analysis.

Here, the generative AI-based new media service transmission system 110 may construct a database by identifying the behavior, preferences, viewing patterns, and the like of a user, and may generate or update the initial user profile.

Here, the generative AI-based new media service transmission system 110 may collect user behavior data using the environmental and contextual metadata.

Here, the generative AI-based new media service transmission system 110 may collect the device type, location, viewing time, clicks, search queries, and the like of a user to identify the environment and situational context of the service, predict how the user uses the service, and optimize the user experience.

Also, the generative AI-based new media service transmission system 110 may analyze profile data using the comprehensive metadata and the metadata for priority-based information delivery.

Here, the generative AI-based new media service transmission system 110 may identify the preferences, viewing patterns, genre preferences, and the like of a user by analyzing the collected data.

Here, the generative AI-based new media service transmission system 110 may set the priority of the service and content based on the information analyzed using the comprehensive metadata and the metadata for priority-based information delivery.

Here, the generative AI-based new media service transmission system 110 may deliver the related content to the recommendation system.

Although the metadata for priority-based information delivery is information for prioritizing important information when delivering data, it may also be used to process more relevant data first in the profile analysis process (e.g., when urgent information or a change in a user's preference in the most recent interaction needs to be processed with higher priority).

Also, the generative AI-based new media service transmission system 110 may perform preference-based analysis using the comprehensive metadata.

Here, the generative AI-based new media service transmission system 110 may generate a content recommendation list based on profiling data in the recommendation system (e.g., determine content suitable for the user by using information such as the topic, genre, purpose, etc. of the content).

The result of preference-based analysis may be used for personalization of content by being integrated into the content generation system.

Also, the generative AI-based new media service transmission system 110 may integrate the recommendation system.

Here, the generative AI-based new media service transmission system 110 may use the analyzed data for a service recommendation algorithm to recommend suitable content based on the text prompt information, and may adjust the prompt to be input into the generative AI according to need.

Here, the generative AI-based new media service transmission system 110 may generate a personalized content recommendation list and select the content most suitable for the user.

Also, the generative AI-based new media service transmission system 110 may reflect interaction and feedback by using the metadata related to content interaction.

Here, the generative AI-based new media service transmission system 110 may track and analyze the behavior of a user using the media content and the response of the user to the media content, store feedback as the metadata related to content interaction, and continuously update the recommendation system and the profiling algorithm.

Also, the generative AI-based new media service transmission system 110 may perform content recommendation and personalization.

Here, the generative AI-based new media service transmission system 110 may recommend customized content to the user by utilizing the already analyzed profile data and may provide a personalized user experience based on the result.

Here, the generative AI-based new media service transmission system 110 applies the user profile generated using the analyzed data to the selection and recommendation of content, thereby presenting the content expected to be most suitable for the user or to be of interest to the user.

Here, the generative AI-based new media service transmission system 110 may perform recommendation algorithm initialization and personalization settings using the text prompt information, the comprehensive metadata, and the metadata for priority-based information delivery.

Here, the generative AI-based new media service transmission system 110 may generate an initial content recommendation list based on the profile data (comprehensive metadata) and preference information (metadata for priority-based information delivery) of the user and perform initial recommendation settings for evaluating the appropriacy and relevance of the recommended content using the text prompt information.

Here, the generative AI-based new media service transmission system 110 may adjust the parameters of the recommendation algorithm by analyzing the interaction data and profile information of the user and perform personalization parameter settings for dynamically selecting the content most suitable for the user.

Also, the generative AI-based new media service transmission system 110 may select and recommend dynamic content using the comprehensive metadata, the metadata for priority-based information delivery, and the metadata related to content interaction.

Here, the generative AI-based new media service transmission system 110 may dynamically update the personalized recommendation list through the user data and preference analysis results updated in real time and may select content by reflecting the response of the user in real time through the metadata related to content interaction as the process of selecting the content to be provided to the user.

Here, the generative AI-based new media service transmission system 110 may set the priority of content using the metadata for priority-based information delivery and provide the most relevant content to the user first.

Here, the generative AI-based new media service transmission system 110 may select the content most suitable for the user preference at the time of determining the content to be finally provided to the user by using the metadata for priority-based information delivery.

Also, the generative AI-based new media service transmission system 110 may reflect feedback on the recommendation result and perform system update.

Here, the generative AI-based new media service transmission system 110 may collect user feedback, which is data (clicks, viewing time, responses, etc.) while the user interacts with the content, and store the user feedback as metadata related to content interaction.

The metadata related to content interaction may be used in order to identify the preferences and behavioral patterns of the user.

Here, the generative AI-based new media service transmission system 110 may continuously adjust and update the recommendation algorithm based on the collected feedback.

Also, the generative AI-based new media service transmission system 110 may determine the optimized content distribution method using the environmental and contextual metadata.

Here, the generative AI-based new media service transmission system 110 may determine the method for distributing the content in a manner that is most suitable for the current situation of the user (the location, device type, network conditions, etc.).

Also, the generative AI-based new media service transmission system 110 may perform content generation and synthesis.

Here, the generative AI-based new media service transmission system 110 may generate various forms of content, such as text, an image, a video, audio, and the like, using generative AI technology.

Here, the text prompt information and media metadata play an important role, and the generative AI-based new media service transmission system 110 may generate media content that reflects the semantic aspect of the content through semantic tag metadata.

Here, the generative AI-based new media service transmission system 110 may set initial content according to service requirements (such as the intent of the service and the media creator) and user data.

Here, the generative AI-based new media service transmission system 110 may satisfy the service requirements for the end viewer through the initial content settings and change content to be personalized.

Here, the generative AI-based new media service transmission system 110 may manage various content versions, monitor effectiveness of each version and user responses thereto, and perform optimization using the content version control metadata.

Also, the generative AI-based new media service transmission system 110 may perform content classification and tagging.

Here, the generative AI-based new media service transmission system 110 may classify the generated content depending on the characteristics thereof by using the media metadata.

Here, the generative AI-based new media service transmission system 110 may effectively manage various content versions using the content version control metadata, determine the most effective content version depending on the user responses, and generate tagging information for reusing or changing the generated content in the future.

Also, the generative AI-based new media service transmission system 110 may prepare for final content review and distribution.

Here, the generative AI-based new media service transmission system 110 may internally review the generated content, check whether the quality matches the user requirements, and prepare the content so as to be provided to the user in the optimal environment and format.

Here, the generative AI-based new media service transmission system 110 may provide the finally generated content to users through various distribution channels.

Here, the generative AI-based new media service transmission system 110 may establish a delivery strategy capable of enhancing the efficiency of content access and distribution using the service delivery priority information.

Here, the generative AI-based new media service transmission system 110 may generate actual delivery data based on the distribution strategy.

Here, the generative AI-based new media service transmission system 110 may generate actual transmission data based on the content delivery format according to the distribution strategy in which the location of the user, the device type, the network condition, and the like are taken into account.

Here, the generative AI-based new media service transmission system 110 may perform processing related to the process of multi-platform distribution of the generated data using various platforms and multiple channels such as web, mobile, and streaming services.

Here, the generative AI-based new media service transmission system 110 may collect interaction data.

Here, the generative AI-based new media service transmission system 110 generates content and readjusts the overall system operation mechanism by collecting data about the use of content by the user (viewing time, clicks, responses, etc.) in real time and identifying the preferences, responses, and behavior patterns of the user by analyzing the collected data, thereby performing system optimization and improvement.

A media service cloud 120 for generative AI-based new media services may additionally perform metadata preprocessing for a generative AI in an existing media service cloud.

Here, the media service cloud 120 for generative AI-based new media services may provide a protocol for generative AI-based media services.

Here, the media service cloud 120 for generative AI-based new media services may provide AI-based adaptive streaming.

Here, the media service cloud 120 for generative AI-based new media services may optimize the service and user experience.

A n adaptive media edge 130 for new media services may provide customized services that personalize content and services in order to provide optimized media services to end users.

Here, the adaptive media edge 130 for new media services may collect service usage information from a reception system and modify a service strategy.

Here, the adaptive media edge 130 for new media services may reproduce generative AI-based media content by itself.

A generative AI-based new media reception system 140 may enable the final service product to be rendered in various environments at the receiving end, and the media content service may be provided differently according to a display and a service reception environment (e.g., an automotive Head-Up Display (HUD), an HMD, a mobile terminal TV, a large screen, etc.)

A generative AI-based media service 150 may reprocess and provide media content services in various service forms to be customized to a user at a receiver with a generative AI installed therein even though the media content services are identical services (e.g., original content based on high-definition video and high-quality audio is delivered as it is, a specific section is delivered with high-quality audio only, content is delivered in a short-form format, a 10-minute summary, an animation style, or the like, content is delivered to express important information, etc.).

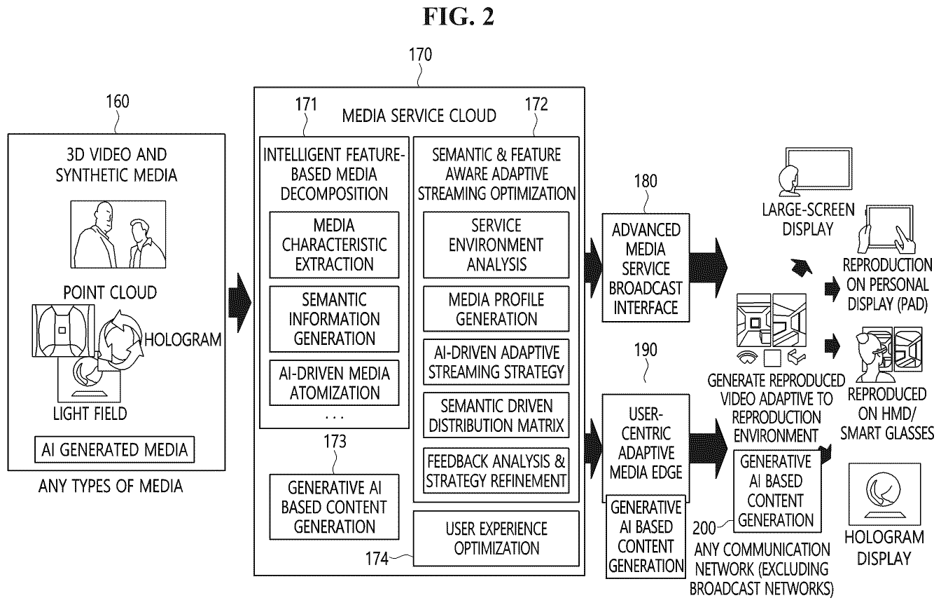

FIG. 2 is a view illustrating transmission and reception concepts depending on a change in a media service cloud according to an embodiment of the present disclosure.

FIG. 2 is a technical concept diagram that shows the entire process from AI-generated media to a user-centric adaptive media experience in media content service provision according to an embodiment of the present disclosure.

The specific content described in the media service cloud may be implemented at a media edge.

Also, generative AI-based media generation may be used at all stages including a media server, a cloud, an edge, and a receiver.

The apparatus for generating media content based on generative AI according to an embodiment of the present disclosure may extract the characteristics and semantic information of media and precisely decompose and reconstruct the media.

Here, the apparatus for generating media content based on generative AI may provide intelligent media streaming technology and transmission technology capable of providing the best QoS and QoE to a user network and user terminal based on the characteristics and semantic information of the media.

AI-generated media 160 may generate media content using artificial intelligence.

For example, in the AI-generated media 160, AI may generate a character, such as a news anchor, or AI may generate a video according to a specific scenario.

The media service cloud 170 may identify the characteristics of media and perform streaming optimization based on the characteristics.

Here, the media service cloud 170 may decompose important characteristics of content using AI and generate meaningful information.

Here, the media service cloud 170 may optimize a user experience, analyze a service environment, and generate a media profile.

Here, the media service cloud 170 may include an intelligent feature-based media decomposition unit 171, a semantic and feature aware adaptive streaming optimization unit 172, a user experience optimization unit 174, and a generative AI-based content generation unit 173.

The intelligent feature-based media decomposition unit 171 may extract the essential characteristics and semantic information of the media.

Here, the intelligent feature-based media decomposition unit 171 may decompose and derive elements that are essential to optimize streaming and improve user experiences.

The intelligent feature-based media decomposition unit 171 may perform a media characteristic extraction function, a semantic information generation function, and an AI-driven media atomization function.

Media characteristic extraction may enable the optimum image quality and sound quality to be provided to a user by analyzing the characteristics of the media.

Semantic information generation involves generating media semantic information in order to provide personalized content by reflecting the preferences, interests, and the like of a user.

AI-driven media atomization involves performing a processing process for splitting large-scale media into smaller units and reconstructing the same using AI in the cloud.

Here, AI-driven media atomization enables functions for efficient media management and transmission to be performed in the cloud and at the edge.

The semantic and feature aware adaptive streaming optimization unit 172 may optimize an adaptive streaming strategy based on the semantic information and features of the media in the cloud.

The semantic and feature aware adaptive streaming optimization unit 172 may perform service environment analysis, media profile generation, an AI-driven adaptive streaming strategy, a semantic-driven distribution matrix, and feedback analysis and strategy refinement.

Service environment analysis may enable streaming environment information to be analyzed by analyzing the network conditions, terminal information, location, and the like of a user.

Media profile generation involves generating a strategic profile for transmitting a media service according to a user environment.

The AI-driven adaptive streaming strategy enables the streaming quality to be continuously adjusted using AI, and the transmission strategy most suitable for the current situation of the user may be provided.

The semantic-driven distribution matrix may be used to analyze the semantic aspects of the content in the process of delivering the media content.

Here, the semantic-driven distribution matrix may be used to identify which information is important to which users based on the important characteristics and metadata of the content, whereby suitable content may be delivered first or more efficiently.

For example, the semantic-driven distribution matrix may enable a user who is highly interested in a specific news event to be provided with news content related to the corresponding event first.

Feedback analysis and strategy refinement may enable the strategy to be continuously optimized by analyzing feedback from a user (e.g., buffering, image quality degradation, etc.).

The user experience optimization unit 174 may generate and optimize customized content based on user input, feedback, and the like.

The generative AI-based content generation unit 173 may generate media content based on generative AI.

An advanced media service broadcast interface 180 refers to an advanced broadcast interface for delivering important portions of media content over a broadcast network.

Here, the advanced media service broadcast interface 180 may broadcast the media processed in the media service cloud.

Here, the advanced media service broadcast interface 180 may provide media content in a broadcast or multicast manner.

Here, the advanced media service broadcast interface 180 may deliver various forms of service elements that are important and are required to be delivered first (such as key scenes of semantic information media, key scenes of media, programs, applications, data, etc.) to the media edge or user environment.

A user-centric adaptive media edge 190 may perform service reprocessing such that media content optimized based on the user experiences is finally provided.

Here, the user-centric adaptive media edge 190 may deliver media adaptively to individual preferences or reception conditions.

Here, the user-centric adaptive media edge 190 may produce and reprocess media through an embedded generative AI.

Here, the user-centric adaptive media edge 190 may create edge-specific services and enable users to experience content through various devices.

Also, the user-centric adaptive media edge 190 prioritizes the reception of critical content, metadata, and related data, thereby generating content that the user needs.

Here, the user-centric adaptive media edge 190 may deliver media adaptively according to individual preferences and situations and may enable content modified in various ways to be experienced through various devices.

A receiver 200 may recognize various reception environments and generate optimal media content based thereon.

Based on the data received from the user-centric adaptive media edge 190 and the service usage information at the receiver, the receiver 200 may reproduce the form of media to be consumed and the final content product according to the reception environment, such as a hospital, a school, military, islands, an urban area, and the like.

Also, although the current media delivery protocol depends on a fixed method, a new protocol that enables dynamic regeneration of media data through edge computing and AI technology may be applied in the present disclosure.

The new protocol determines the meaning and significance of content in real time and provides necessary metadata, thereby maximizing user experiences.

In the structure in which a customized service is finally delivered through the process of continuously regenerating media during delivery, whether the intent and quality of the original content are accurately delivered to end users in the media regeneration process is important.

Therefore, the media edge and the user terminal are required to share sufficient information for correctly interpreting and realizing the intent of the creator of the original content, whereby the needs and intent of the author and content provider may be clearly delivered when media is transmitted.

As an example of the method of providing media semantics, MPEG 7 provides a framework for describing rich metadata about multimedia content, and information about objects, events, places, time, and the like may be described in detail.

However, explicit instructions on the elements that should remain unchanged and the elements that can be freely modified by a generative AI are not directly defined in MPEG 7 and any other standards or technology.

Also, a prompt of a generative AI may describe what a user wants in text to some extent, but it has limitations in providing specific information.

Therefore, when it is necessary to more precisely control the prompt of a generative AI (e.g., a rule that a certain segment should not be modified, etc.), additional protocols or extension are required.

Such a rule is a mechanism for controlling the operation method of a generative AI, and may be implemented by adding the following explicit constraints to the existing structure of MPEG 7 according to an embodiment of the present disclosure.

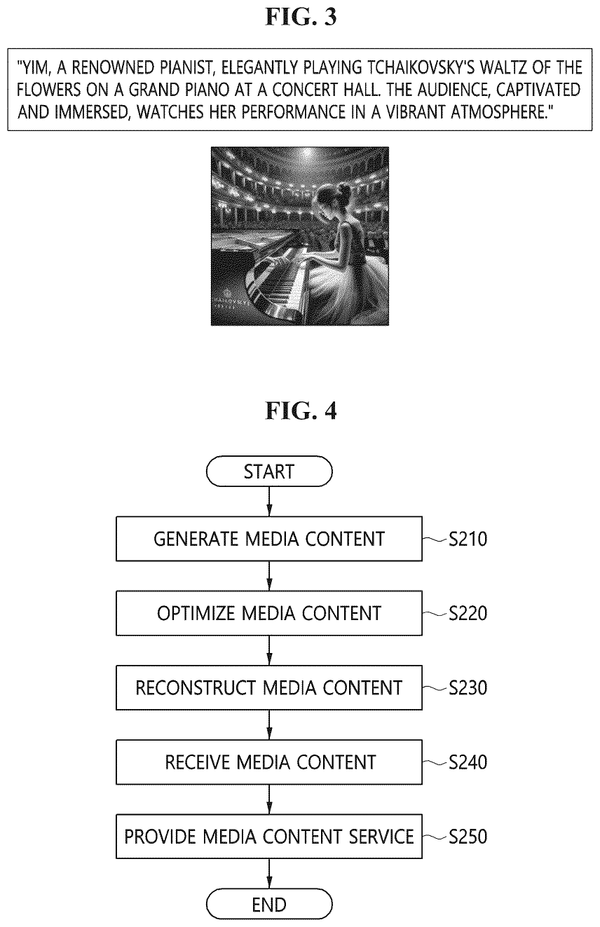

FIG. 3 is a view illustrating an image generated by a generative AI model using media semantic information according to an embodiment of the present disclosure.

Referring to FIG. 3, it can be seen that the image generated by a generative AI model using media semantic information required to generate a concert scene, including a woman playing the piano and an audience immersed therein, is illustrated. As an example of the generative AI model, there is DALL-E.

Here, the key image generated by configuring a prompt that can be understood by a generative AI, such as that illustrated in FIG. 3, may be used to generate a video and may be the information that should be delivered first.

A n example of similar content represented using MPEG 7 may be as shown in pseudocode 1.

### [Pseudocode 1]

<SemanticBase xsi:type=“A gentO bjectType” id=“FamousPianist”>
<Label>
<Name>A</Name>
</Label>
<Definition>
<StructuredAnnotation>
<Who rdf:about=“#PianistA”>
<Name>A</Name>
<Background>A renowned pianist known for her interpretation of classical pieces.</Background>
</Who>
</StructuredA nnotation>
</Definition>
<Relation type=“identity” target=“#Pianist”/>
<Relation type=“hasPerformed”target=“#WValtzOfTheFlowers”/>
</SemanticBase>
<SemanticBasexsi:type=“EventObjectType” id=“ConcertExperience”>
<Label>
<Name>ConcertExperience</Name>
</Label>
<Definition>
<FreeTextAnnotation>The concert atmosphere is vibrant and the audience is diverse, allowing for a wide range of visual interpretations. </FreeTextAnnotation>
</Definition>
</SemanticBase>

In this example, the appearance of the audience may be information that is not important in the scene in which the pianist is playing music. In the existing broadcast system, it is important to accurately reproduce an image captured by a camera, pixel by pixel, at a receiver to show even the appearance of the audience by transmitting the image to the receiver. However, in the present disclosure, such information is an element that is not important in the content, so a generative AI may generate it by itself, whereby the amount of data that should be delivered from the transmitting end may be significantly reduced.

For example, information that a pianist must be a specific person may be used as very critical information in the generation process, but instructions that an audience can be freely generated may be a method to give creative freedom to a generative AI for the corresponding part.

This information may be used as important information for reducing resources for media processing and may also be used as important information for providing customized content.

Therefore, constraints or constraint information may be defined in media content delivery in the present disclosure. The constraint information may be used to determine a part of the content that should be delivered without change and a part of the content that can be modified by a generative AI.

The constraint information may include information for clearly describing specific constraints applied to media content and the aspects of the content (e.g., image quality, audio integrity, important content elements, etc.) to which these constraints are applied.

The constraint information is delivered first in the content delivery and generation process, and when reprocessing and generating content, the constraint information may be key information through which the intent of the creator and service distributor can be reflected and through which a customized service can be provided.

Particularly, the constraint information may specify criteria for the part of the content in which a specific content element should remain unchanged as in the original and the part of the content allowed to be modified by a generative AI.

For example, in order to include this information in the specification of MPEG 7, elements such as pseudocode 2 may be added as constraint information.

### [Pseudocode 2]

<Constraint>
<ConstrainedObjectidref=“IdentifiedObject”/>
<Condition type=“immutable”/>
</Constraint>
<Constraint>
<ConstrainedObject idref=“FlexibleObject”/>
<Condition type=“mutable”/>
</Constraint>

Here, IdentifiedObject and FlexibleObject may refer to an object that should not be modified and a modifiable object, respectively, and ‘immutable’ and ‘mutable’ may specify the processing method of AI for the corresponding objects.

There are various constraints that can be provided to a generative AI, and these may be important to make a generative AI follow specific conditions or rules in the process of generating or modifying content.

The followings are examples of constraint information that can be used.

Content-specific constraints may provide guidelines on the method of representing a specific content element (e.g., a specific person, an object, or a background) in the generated media.

For example, the content-specific constraints may be used when a specific person or object should be always represented in a specific manner.

Style constraints may provide guidelines on the visual and auditory style of the generated content.

For example, the style constraints may specify a specific color palette, a painting style, a music genre, and the like.

Contextual constraints may provide guidelines such that content is generated according to a specific situation or context.

For example, the contextual constraints may reflect a particular historical background or cultural context.

Emotional or thematic constraints may provide guidelines such that content reflects a specific emotion or theme.

For example, the emotional and thematic constraints may provide guidelines such that content represents a specific emotion or theme, such as happiness, sadness, adventure, or the like.

Duration or size constraints may set limits on the length or size of content.

For example, the duration or size constraints may specify the length of a video, the resolution of an image, and the like.

Legal or ethical constraints may provide guidelines such that content is generated in compliance with legal and ethical standards.

For example, the legal and ethical constraints may provide guidelines to avoid the use of copyrighted materials or to include appropriate content when generating content for users in a specific age group.

A n embodiment of each of the constraints described above may be represented as shown in pseudocode 3.

### [Pseudocode 3]

### Content-Specific Constraints:

<Constraint>
<ConstrainedObjectidref=“SpecificObject”/>
<Condition type=“representation” value=“realistic”/>
</Constraint>

### Style Constraints:

<Constraint>
<ConstrainedObject idref=“ArtisticContent”/>
<Condition type=“style” value=“impressionist”/>
</Constraint>

### Contextual Constraints:

<Constraint>
<ConstrainedObject idref=“HistoricalScene”/>
<Condition type=“era” value=“medieval”/>
</Constraint>

### Emotional or Thematic Constraints:

<Constraint>
<ConstrainedObject idref=“EmotionalContent”/>
<Condition type=“mood” value=“joyful”/>
</Constraint>

### Duration or Size Constraints:

<Constraint>
<ConstrainedObject idref=“VideoClip”/>
<Condition type=“duration” value=“60s”/>
</Constraint>

### Legal or Ethical Constraints:

<Constraint>
<ConstrainedObject idref=“ContentForK ids”/>
<Condition type=“age-appropriate” value=“true”/>
</Constraint>

FIG. 4 is a flowchart illustrating a method for providing a media content service based on generative AI according to an embodiment of the present disclosure.

Referring to FIG. 4, in the method for providing a media content service based on generative AI according to an embodiment of the present disclosure, first, media content may be generated at step S210.

That is, at step S210, existing media and synthetic media generated using a generative AI (AI-generated media) are combined, whereby a new type of combined media may be generated.

Here, at step S210, metadata for the generative AI may be generated for the combined media, and media content may be created based on the generative AI.

Also, in the method for providing a media content service based on generative AI according to an embodiment of the present disclosure, the media content may be optimized at step S220.

That is, at step S220, preprocessing of the metadata for the generative AI may be additionally performed in an existing media services cloud.

Here, at step S220, a protocol for a generative AI-based media service may be provided.

Here, at step S220, AI-based adaptive streaming may be provided.

Here, at step S220, a service and a user experience may be optimized.

Also, in the method for providing a media content service based on generative AI according to an embodiment of the present disclosure, the media content may be reconstructed at step S230.

That is, at step S230, in order to provide an optimized media service to an end user, a customized service that personalizes content and a service may be provided.

Here, at step S230, service usage information may be collected from a reception system, and a service strategy may be modified.

Here, at step S230, generative AI-based media content may be autonomously reproduced.

Also, in the method for providing a media content service based on generative AI according to an embodiment of the present disclosure, the media content may be received at step S240.

That is, at step S240, at the receiving end, the final service product may be rendered in various environments, and the media content service may be provided differently according to a display and a service reception environment (e.g., an automotive Head-Up Display (HUD), an H M D, a mobile terminal TV, a large screen, etc.).

Also, in the method for providing a media content service based on generative AI according to an embodiment of the present disclosure, the media content service may be provided at step S250.

That is, at step S250, the media content services may be reprocessed and provided in various service forms to be customized to a user at a receiver with a generative AI installed therein even though the media content services are identical services (e.g., original content based on high-definition video and high-quality audio is delivered as it is, a specific section is delivered with high-quality audio only, content is delivered in a short-form format, a 10-minute summary, an animation style, or the like, content is delivered to express important information, etc.).

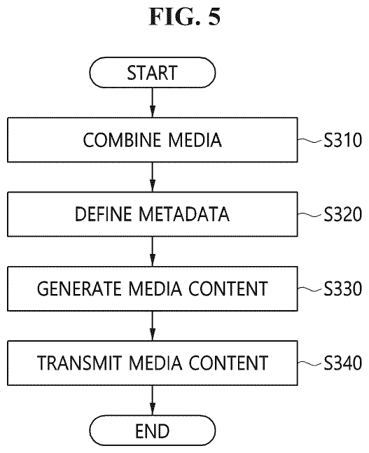

FIG. 5 is a flowchart illustrating a method for generating media content based on generative AI according to an embodiment of the present disclosure.

Referring to FIG. 5, it can be seen that the method for generating media content based on generative AI according to an embodiment of the present disclosure shows in detail an example of the step of generating media content illustrated in FIG. 4.

In the method for generating media content based on generative AI according to an embodiment of the present disclosure, first, media may be combined at step S310.

That is, at step S310, existing media and synthetic media generated using a generative AI (AI-generated media) are combined, whereby a new type of combined media may be generated.

Here, at step S310, an existing media source may be analyzed.

Here, at step S310, key data points (e.g., key scenes, characters, dialogue, etc.) are identified in the existing media (broadcast or streaming content), and in this process, image and audio recognition technology, and the like may be used.

Here, at step S310, synthetic media (e.g., images, text, audio clips, etc. generated by AI) may be generated based on a generative AI.

Here, at step S310, synthetic media highly related to the context of the existing media may be generated based on the analysis of the existing media source.

Here, at step S310, the existing media may be combined with the synthetic media by adding the synthetic media thereto in post-production.

Here, at step S310, multi-layered storytelling or diversity may be enhanced by creating a video using conventional technology and then adding the synthetic media to specific scenes or elements.

Here, at step S310, the target scene or element to which the synthetic media is to be added may be selected in the existing media.

Here, at step S310, the synthetic image or video to be inserted in the target scene may be generated using an AI-based tool.

Here, at step S310, the generated synthetic media may be combined with the existing media using a digital synthesis tool.

Here, at step S310, additional elements are added to the already completed video, whereby richer content may be generated (e.g., adding special effects, changing a background, or modifying specific characters or objects according to a new scenario).

Here, at step S310, the existing media and the synthetic media may be combined in an integrated creation process.

Here, at step S310, media may be created by preplanning the combination of the existing media and the synthetic media from the initial production stage.

Here, at step S310, when creating the media, the scene or element to be created as synthetic media may be planned in an initial concept storyboard creation stage.

Here, at step S310, synthetic media may be created using A 1.

Here, at step S310, the created synthetic media and the existing media (a live-action video) are combined, and final editing may be performed.

Here, at step S310, the efficiency of the creation process may be improved, and flexibility may be increased when content is created (e.g., virtual reality (VR) or augmented reality (AR) content creation, interactive storytelling, etc.).

Here, at step S310, dynamic synthesis for combining the existing media and the synthetic media may be performed by reflecting information input by a user at a receiving end where media content is received in real time (information about the use of a service by the user and requirements delivered from the receiving end to a transmitting end).

Dynamic synthesis may be performed not only at the service generation stage but also at the media edge or service receiving end.

Here, at step S310, the synthetic media content may be selected and generated by processing and analyzing the requirements of the user in real time.

Here, at step S310, the user input data may be analyzed, real-time synthetic media based on the user input data may be directed and generated (creating a changed background, changed characters, etc. using AI and real-time rendering technology), and synthetic media may be created using an AI-based tool.

Dynamic synthesis may be performed at the existing media and streaming service level or at the graphics engine level.

Dynamic synthesis may be used in games, educational content, and the like in order to show different storylines or products depending on the selection or behavior of the user.

Here, at step S310, adaptive-storytelling-based synthesis may be performed.

Here, at step S310, the storyline or content may be automatically adjusted based on previous data, such as the preferences of viewers.

Here, at step S310, personalization of content provision may be provided by considering the long-term service experience and preferences of the viewer.

Here, at step S310, user analysis data, such as the viewing history and preferences of the user, may be analyzed.

Here, at step S310, the synthetic media to be combined with the existing media may be determined based on the user analysis data.

Here, at step S310, the synthetic media may be combined with the existing media by generating customized content.

Here, at stage S310, in order to optimize the user experience, user responses may be continuously monitored, and the content provision method may be updated.

Here, at step S310, the content generated by adjusting the detailed characteristics and attributes of the content using media metadata is integrated with the existing media resources, whereby new media may be generated.

Adaptive-storytelling-based synthesis refers to a scenario in which a viewing genre, actors, and the like are adjusted depending on the past viewing history of the user, and a customized trailer and the like may be created as the synthetic media.

Adaptive-storytelling-based synthesis may provide user profiling for long-term analysis of user data and content recommendation algorithms.

Also, in the method for generating media content based on generative AI according to an embodiment of the present disclosure, metadata may be defined at step S320.

That is, at step S320, metadata required for a generative AI to generate media content may be defined for the combined media.

Here, at step S320, a metadata generation process and the structure and expression method of metadata may be defined.

Here, at step S320, detailed information about a text prompt for the generative AI may be defined in the form of metadata.

Here, at step S320, detailed information about the content and intent of the text prompt, a situation in which the text prompt is used, and the like is defined and described in the form of metadata, whereby the generative AI may generate content that effectively reflects the intent of a creator.

Here, at step S320, background knowledge required for the generative AI to generate appropriate content based on the provided text information may be provided.

Here, at step S320, a key image generated by configuring a prompt that can be understood by the generative AI is used to generate a video and may be set as the information that should be delivered first.

Here, at step S320, constraints or constraint information may be defined in media content delivery.

Here, the constraint information may be included in text prompt information.

Here, the constraint information may be used to determine a part of the content that should be delivered without change and a part of the content allowed to be modified by the generative AI.

Here, the constraint information may include information for clearly describing specific constraints applied to media content and the aspects of the content (e.g., image quality, audio integrity, important content elements, etc.) to which these constraints are applied.

Here, the constraint information may be delivered first in the content delivery and generation process, and may be used as key information based on which a customized service can be provided while reflecting the intent of a creator and service distributor when reprocessing and generating content.

In particular, the constraint information may specify criteria for the part of the content in which a specific content element should always remain unchanged as in the original and the part of the content allowed to be modified by the generative AI.

Here, the constraint information may specify objects that should not be altered and objects that can be altered in the media content and the method of processing the objects by AI.

Here, the constraint information may include guidelines for modifying the part of the content allowed to be modified by the generative AI according to a specific condition.

Here, the generative AI may freely modify the part of the content allowed to be modified by the generative AI when the constraint information does not include guidelines for modification according to the specific condition.

Here, at step S320, media metadata that enables various forms of media input to be processed may be defined.

The media metadata refers to metadata required for a generative AI to process various forms of media input, such as an image, sound, a short video and the like, as well as a text prompt, and may provide information about a media file itself.

The media metadata may include metadata that describes the method of using each type of media, the meaning, the context, and the like, and may include information, such as the creation date, length, format, copyright, and the like of media, for a generative AI to understand and appropriately process various forms of input.

Comprehensive metadata related to media orchestration refers to metadata for increasing the efficiency of content provision and enhancing user experiences in an environment in which various forms of media content and services are integrated.

Here, the comprehensive metadata related to media orchestration refers to comprehensive metadata including information about the topic, genre, purpose, characteristics, and the like of the media service and content to be generated, and may describe information about how, when, in which form the service or content is to be provided.

Here, the comprehensive metadata related to media orchestration may include strategy information related to combination-related strategy information about the method of providing different forms of media content to be customized to a user.

Also, the comprehensive metadata related to media orchestration may include user profiles and preference information such that content is created according to a specific situation and user requirements.

Here, the comprehensive metadata related to media orchestration may be used to define the direction and context of the content to be generated by AI.

Metadata for priority-based information delivery refers to metadata required to implement a mechanism for prioritizing the delivery of important information, among all the data delivered from the service transmitting end to a generative AI.

Here, the metadata for priority-based information delivery may define the importance of each information item and set the priority of information such that the generative AI processes the most important information first.

Here, the metadata for priority-based information delivery refers to metadata to be applied at the delivery stage in order to optimize the content generation process of the generative AI and to efficiently generate important content first.

Metadata related to content interaction refers to metadata about a method in which a user interacts with the generated content, and may be used later in order to enhance and personalize the service.

For example, the metadata related to content interaction may include information about the parts of specific content in which a user is more interested or the response of the user.

Here, the metadata related to content interaction may include essential information for analysis of user behavior, extraction of preferences, and the mechanism of a content recommendation system.

Semantic tag metadata is for explicitly tagging individual elements or scenes in the content with the meaning thereof and for classifying the same, and the semantic tag for each part may be included as metadata.

Here, the semantic tag metadata may be used to help AI better understand the meaning of the content and to recommend relevant content or perform search (e.g., tag information about specific objects or scenes in a video).

Content version control metadata refers to metadata for managing different versions of generated content.

Here, the content version control metadata refers to metadata for recording information, such as how the content has evolved over time, the version that received a more positive response from a user, and the like.

Environmental and contextual metadata refers to metadata for information about the environment and context in which content is generated or consumed.

Here, the environmental and contextual metadata may include information such as the location of a user, a time zone, a device type, and the like, and may be used for a content distribution method.

Also, in the method for generating media content based on generative AI according to an embodiment of the present disclosure, media content may be generated at step S330.

That is, at step S330, the text prompt to be input into the generative AI is adjusted using the metadata, whereby the media content may be generated by the generative AI.

Here, at step S330, the process of updating a profile by collecting and analyzing user data through user profiling and data analysis may be repeated.

Here, at step S330, a database may be constructed by identifying the behavior, preferences, viewing patterns, and the like of a user, and an initial user profile may be generated or updated.

Here, at step S330, user behavior data may be collected using the environmental and contextual metadata.

Here, at step S330, the environment and situational context of the service are identified by collecting the device type, location, viewing time, clicks, search queries, and the like of a user, and how the user uses the service is predicted, whereby the user experience may be optimized.

Here, at step S330, the profile data may be analyzed using the comprehensive metadata and the metadata for priority-based information delivery.

Here, at step S330, the preferences, viewing patterns, genre preferences, and the like of the user may be identified by analyzing the collected data.

Here, at step S330, the priority of the service and content may be set using the information analyzed using the comprehensive metadata and the metadata for priority-based information delivery.

Here, at step S330, the relevant content may be delivered to the recommendation system.

Although the metadata for priority-based information delivery is information for prioritizing important information when delivering data, it may also be used to process more relevant data first in the profile analysis process (e.g., when urgent information or a change in a user's preference in the most recent interaction needs to be processed with higher priority).

Here, at step S330, preference-based analysis may be performed using the comprehensive metadata.

Here, at step S330, a content recommendation list based on the profiling data may be generated in the recommendation system (e.g., content suitable for the user is determined using information such as the topic, genre, purpose, etc. of the content).

The result of preference-based analysis may be used for personalization of content by being integrated into the content generation system.

Here, at step S330, the recommendation system may be integrated.

Here, at step S330, using the analyzed data, the service recommendation algorithm may recommend suitable content based on the text prompt information, and the prompt to be input into the generative AI may be adjusted according to need.

Here, at step S330, a personalized content recommendation list may be generated, and the most suitable content may be selected for the user.

Here, at step S330, interaction and feedback may be reflected using the metadata related to content interaction.

Here, at step S330, the behavior of the user using the media content and the response of the user to the media content are tracked and analyzed, the feedback is stored as the metadata related to content interaction, and the recommendation system and the profiling algorithm may be continuously updated.

Here, at step S330, content recommendation and personalization may be performed.

Here, at step S330, customized content may be recommended to the user using the already analyzed profile data, and based on the result thereof, a personalized user experience may be provided.

Here, at step S330, the user profile generated using the analyzed data is applied to the selection and recommendation of content, whereby the content expected to be most suitable for the user or to be of interest to the user may be presented.

Here, at step S330, recommendation algorithm initialization and personalization settings may be performed using the text prompt information, the comprehensive metadata, and the metadata for priority-based information delivery.

Here, at step S330, an initial content recommendation list is generated based on the profile data (comprehensive metadata) and preference information (metadata for priority-based information delivery) of the user, and initial recommendation settings for evaluating the appropriacy and relevance of the recommended content may be performed using the text prompt information.

Here, at step S330, the parameters of the recommendation algorithm are adjusted by analyzing the interaction data and profile information of the user, and personalization parameter settings for dynamically selecting the content most suitable for the user may be performed.

Here, at step S330, dynamic content may be selected and recommended using the comprehensive metadata, the metadata for priority-based information delivery, and the metadata related to content interaction.

Here, at step S330, the personalized recommendation list is dynamically updated through the user data and preference analysis results updated in real time, and content may be selected by reflecting the user response in real time through the metadata related to content interaction in the process of selecting the content to be provided to the user.

Here, at step S330, the priority of content is set using the metadata for priority-based information delivery, and the most relevant content may be provided to the user first.

Here, at step S330, the content most suitable for the user preference at the time of determining the content to be finally provided to the user may be selected using the metadata for priority-based information delivery.

Here, at step S330, feedback on the recommendation result may be reflected, and system update may be performed.

Here, at step S330, user feedback, which is data (clicks, viewing time, responses, etc.) while the user interacts with the content, may be collected and stored as the metadata related to content interaction.

The metadata related to content interaction may be used in order to identify the preferences and behavioral patterns of the user.

Here, at step S330, the recommendation algorithm may be continuously adjusted and updated based on the collected feedback.

Here, at step S330, the optimal content distribution method may be determined using the environment and contextual metadata.

Here, at step S330, the method for distributing the content in a manner that is most suitable for the current situation of the user (the location, device type, network conditions, etc.) may be determined.

Here, at step S330, content generation and synthesis may be performed.

Here, at step S330, various forms of content, such as text, an image, a video, audio, and the like, may be generated using generative AI technology.

Here, at step S330, the text prompt information and media metadata play an important role, and media content that reflects the semantic aspect of the content may be generated through the semantic tag metadata.

Here, at step S330, initial content may be set according to service requirements (such as the intent of the service and media creator) and user data.

Here, at step S330, service requirements may be satisfied through the initial content settings and modification for personalization may be performed for the end viewer.

Here, at step S330, various content versions are managed, and using the content version control metadata, the effectiveness of each version and the user response thereto may be monitored, and optimization may be performed.

Here, at step S330, content classification and tagging may be performed.

Here, at step S330, using media metadata, the generated content may be classified depending on the characteristics thereof.

Here, at step S330, various content versions may be effectively managed using the content version control metadata, the most effective content version may be determined based on the user response, and tagging information for reusing or changing the generated content in the future may be generated.

Here, at step S330, the final content review and distribution may be prepared for.

Here, at step S330, the generated content may be internally reviewed, whether the quality matches the user requirements may be checked, and the content may be prepared to be provided to the user in the optimal environment and format.

Here, at step S330, the finally generated content may be provided to the user through various distribution channels.

Here, at step S330, a delivery strategy capable of increasing the efficiency of content access and distribution may be established using the service delivery priority information.

Also, in the method for generating media content based on generative AI according to an embodiment of the present disclosure, the media content may be transmitted at step S340.

That is, at step S340, actual delivery data based on the distribution strategy may be generated.

Here, at step S340, actual transmission data based on the content delivery format according to the distribution strategy in which the location, device type, network conditions, and the like of the user are taken into account may be generated.

Here, at step S340, processing related to the process of multi-platform distribution of the generated data may be performed using various platforms and multiple channels, such as web, mobile, and streaming services, and the like.

Here, at step S340, interaction data may be collected.

Here, at step S340, content generation and readjustment of the overall system operation mechanism are performed by collecting data on the use of the content by a user (viewing time, clicks, responses, etc.) in real time and by identifying the preferences, responses, and behavioral patterns of the user through analysis of the collected data, whereby optimization and improvement of the system may be performed.

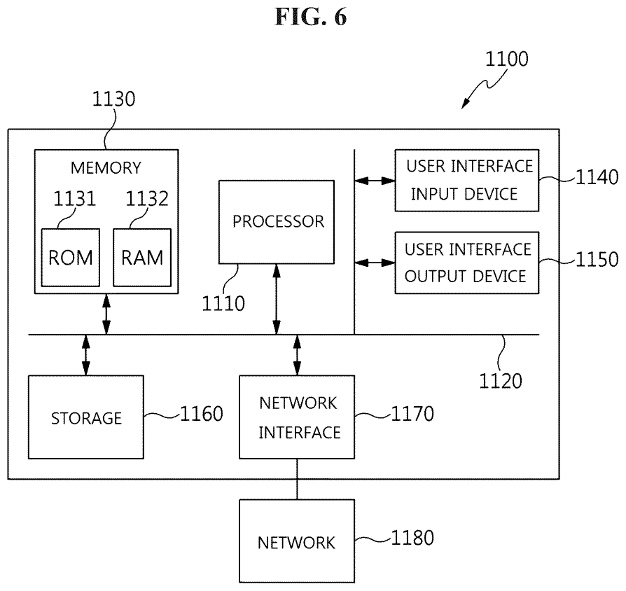

FIG. 6 is a view illustrating a computer system according to an embodiment of the present disclosure.

Referring to FIG. 6, the apparatus 100 for generating media content based on generative AI according to an embodiment of the present disclosure may be implemented in a computer system 1100 including a computer-readable recording medium. As illustrated in FIG. 6, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RA M 1132.

The apparatus for generating media content based on generative AI according to an embodiment of the present disclosure includes one or more processors 1110 and memory 1130 for storing at least one program executed by the one or more processors 1110, and the at least one program generates combined media by combing existing media with synthetic media generated using a generative AI, defines metadata required for the generative AI to generate media content for the combined media, and adjusts the text prompt to be input into the generative AI using the metadata, thereby generating the media content using the generative AI.

Here, the at least one program may combine the existing media and the synthetic media by reflecting information input by a user at a receiving end where the media content is received.

Here, detailed information about the text prompt may be defined in the form of metadata.

Here, the metadata may include constraint information that specifies criteria for a part of content in which the original of the media content should remain unchanged and a part of the content allowed to be modified by the generative AI.

Here, the constraint information may include guidelines for modifying the part of the content allowed to be modified by the generative AI according to a specific condition.

Here, the generative AI may freely modify the part of the content allowed to be modified by the generative AI when the constraint information does not include the guidelines for the modification according to the specific condition.

Here, the metadata may include user profile and preference information for providing the media content to be customized for the user.

Here, the metadata may include information about priority for the generative AI to process the most important information first when generating the media content.

Here, the metadata may include tagging information explicitly added for the generative AI to understand the meaning of individual elements in the media content.

Here, the at least one program may track and analyze the behavior of the user using the media content and the response of the user to the media content and store feedback for media content recommendation as the metadata.

The present disclosure may facilitate the efficient creation, distribution, and reprocessing of media content and build a new media service environment that more precisely responds to the preference and demand of individual users.

Also, the present disclosure generates and optimizes data in real time at a media edge or a receiver, thereby providing a continuous and seamless media experience.

Also, the present disclosure may enhance user experiences and overall service transmission and reception efficiency by using a media content service transmission network more efficiently than existing services.

Also, the present disclosure may provide customized content to users and optimize network resources by intellectualizing the process of delivering and generating media content.

Also, the present disclosure significantly reduces the amount of data transmission and simultaneously enables a variety of rich media experiences, thereby greatly improving user satisfaction.

Also, the present disclosure may provide seamless content viewing to users by generating media content even when transmission of media is interrupted.

As described above, the apparatus and method for generating media content based on generative AI according to the present disclosure are not limitedly applied to the configurations and operations of the above-described embodiments, but all or some of the embodiments may be selectively combined and configured, so the embodiments may be modified in various ways.

What is claimed is:

1. A n apparatus for generating media content based on generative AI, comprising:
one or more processors; and
memory for storing at least one program executed by the one or more processors,
wherein the at least one program
generates combined media by combining existing media with synthetic media generated using a generative AI,
defines metadata required for the generative AI to generate media content for the combined media, and
generates the media content using the generative AI by adjusting a text prompt to be input into the generative AI using the metadata.

2. The apparatus of claim 1, wherein the at least one program combines the existing media with the synthetic media by reflecting information input by a user at a receiving end where the media content is received.

3. The apparatus of claim 1, wherein the at least one program defines detailed information about the text prompt in a form of metadata.

4. The apparatus of claim 3, wherein the metadata includes constraint information that specifies criteria for a part of content in which an original of the media content should remain unchanged and a part of the content allowed to be modified by the generative AI.

5. The apparatus of claim 4, wherein the constraint information includes a guideline for modifying the part of the content allowed to be modified by the generative AI according to a specific condition.

6. The apparatus of claim 5, wherein the generative AI freely modifies the part of the content allowed to be modified by the generative AI when the constraint information does not include the guideline for modification according to the specific condition.

7. The apparatus of claim 1, wherein the metadata includes user profile and preference information for providing the media content to be customized to a user.

8. The apparatus of claim 1, wherein the metadata includes information about priority for the generative AI to process most important information first when generating the media content.

9. The apparatus of claim 1, wherein the metadata includes tagging information explicitly added for the generative AI to understand meaning of individual elements in the media content.

10. The apparatus of claim 1, wherein the at least one program tracks and analyzes behavior of a user using the media content and a response of the user to the media content and stores feedback for media content recommendation as the metadata.

11. A method for generating media content based on generative AI, performed by an apparatus for generating media content based on generative AI, comprising:
generating combined media by combining existing media with synthetic media generated using a generative AI;
defining metadata required for the generative AI to generate media content for the combined media; and
generating the media content using the generative AI by adjusting a text prompt to be input into the generative AI using the metadata.

12. The method of claim 11, wherein generating the combined media comprises combining the existing media with the synthetic media by reflecting information input by a user at a receiving end where the media content is received.

13. The method of claim 11, wherein defining the metadata comprises defining detailed information about the text prompt in a form of metadata.

14. The method of claim 13, wherein the metadata includes constraint information that specifies criteria for a part of content in which an original of the media content should remain unchanged and a part of the content allowed to be modified by the generative AI.

15. The method of claim 14, wherein the constraint information includes a guideline for modifying the part of the content allowed to be modified by the generative AI according to a specific condition.

16. The method of claim 15, wherein the generative AI freely modifies the part of the content allowed to be modified by the generative AI when the constraint information does not include the guideline for modification according to the specific condition.

17. The method of claim 11, wherein the metadata includes user profile and preference information for providing the media content to be customized to a user.

18. The method of claim 11, wherein the metadata includes information about priority for the generative AI to process most important information first when generating the media content.

19. The method of claim 11, wherein the metadata includes tagging information explicitly added for the generative AI to understand meaning of individual elements in the media content.

20. The method of claim 11, wherein generating the media content comprises tracking and analyzing behavior of a user using the media content and a response of the user to the media content and storing feedback for media content recommendation as the metadata.
